(19) United States
(12) Patent Application Publication
(10) Pub. No.: US 2002/0154190 A1
(43) Pub. Date: Oct. 24, 2002

(54) Ink jet recording head and fabrication method thereof

(75) Inventors: Kenichi Ohno, Tokyo (JP); Takashi Yagi, Tokyo (JP); Torahiko Kanda, Tokyo (JP)

Correspondence Address: YOUNG & THOMPSON, 745 SOUTH 23RD STREET 2ND FLOOR, ARLINGTON, VA, 22202

(73) Assignee: FUJI XEROX CO., LTD., Tokyo (JP)

(21) Appl. No.: 10/123,407

(22) Filed: Apr. 17, 2002

(30) Foreign Application Priority Data
Apr. 24, 2001 (JP) 2001-126213

(51) Int. Cl. B41J 2/135

(52) U.S. Cl. 347/47; 347/45

(57) ABSTRACT

In an ink jet recording head including a silicon substrate and at least one ink chamber and at least one ink pool, which are formed in the silicon substrate with a partition wall therebetween, an opening portion is formed in a position corresponding to an apex of the ink pool of one surface of the silicon substrate on which an opening portion for etching the ink chamber is formed and anisotropic etching of the silicon substrate through the opening portion is performed such that an etching from a bottom of the ink pool and the etching from the opening portion are connected to each other immediately below the opening portion to absorb deviation between etching patterns on both surfaces of the silicon substrate to thereby reduce a variation of thickness of the partition wall and to reduce an influence of such deviation on an ink filling function and an ink jetting function of the ink jet recording head.

### BACKGROUND OF THE INVENTION

1. Field of the Invention

The present invention relates to an ink jet recording head for recording an image or the like by jetting ink droplets to a recording medium and a fabrication method thereof.

2. Description of the Related Art

An ink jet recording head and a fabrication method thereof are proposed in US-2001-0033313-A1 assigned to the assignee of the present application, in which the ink jet recording head includes at least one nozzle for jetting ink droplets, at least one ink chamber in communication with the nozzle for pressurizing ink filling the ink chamber, at least one ink pool for supplying ink to the ink chamber, a main ink pool connected to the ink pool for supplying ink from an ink tank to the ink pool and an ink supply port to be connected to the ink tank, all of which are formed in a silicon substrate. In the ink jet recording head proposed, the nozzle is formed vertically in one of crystal faces {100} of the silicon substrate and the ink chamber and the ink pool are formed by anisotropic etching such that wall surfaces of the ink chamber and the ink pool become crystal face {111}.

The proposed fabrication method will be described with reference to FIG. 4a to FIG. 4g, which show fabrication steps for forming a unit pair of the nozzle and the ink pool in one and the same silicon substrate.

First, a high density boron diffusion layer 2 is formed in crystal face {100} of the silicon wafer 1 shown in FIG. 4a as a layer in which the nozzle is formed (FIG. 4b). And then, as shown in FIG. 4c, a silicon oxide layer 3, which becomes an anti etching mask material, is formed on a surface of the silicon wafer 1 by thermal oxidation. Thereafter, the silicon oxide layer 3 is painted with resist material and a resist mask pattern of the nozzle on the wafer surface is formed by photolithography. Thereafter, the silicon oxide layer 3 is etched to open the nozzle in a direction perpendicular to the high density boron diffusion layer by dry etching with using the silicon oxide layer 3 as a mask (FIG. 4d). In order to provide opening portions through which the ink chamber and the ink pool are to be formed, a resist pattern is formed. After the silicon oxide layer 3 is etched, the resist is peeled off and the high density boron diffusion layer is etched by using the silicon oxide layer 3 as a mask (FIG. 4e). And then, the ink chamber 11 and the ink pool 12 are formed in crystal face {111} by anisotropic etching of silicon as shown in FIG. 4f. Thereafter, a cover plate of the ink pool 12 is formed as shown in FIG. 4g and the ink supply path 13 is formed between the ink chamber 11 and the ink pool 12. Further, a pressure generation mechanism 14 such as piezo electric element is provided by bonding or forming a cover plate on the bottom of the ink chamber.

An example in which there is a deviation between axes of the ink chamber and the nozzle in a connecting portion between them is shown in FIG. 5a, which is a cross section showing the connecting portion between the ink chamber and the nozzle, and FIG. 5b, which is a plan view of the nozzle when looked from the bottom of the ink chamber.

Since the ink chamber is formed in the silicon substrate by anisotropic etching, crystal faces {111} appear in wall surfaces thereof and the ink chamber is a cavity takes in the form of a pyramid and has the nozzle opened at an apex thereof.

When the ink jet recording head is fabricated in the silicon substrate by utilizing the semiconductor fabricating steps, it is possible to make the ink jet recording head compact. Further, since it becomes possible to perform a highly precise machining, it becomes possible to fabricate a high density and highly precise ink jet recording head.

However, when the ink chamber and the ink pool are formed in the silicon substrate by using the photo etching technique, there may be a positional deviation between the ink chamber and the ink pool. As shown in FIG. 4a and FIG. 4b, the ink chamber and the ink pool is partitioned by a parallel partition wall and tapering directions thereof are opposite to each other. In such case, since opening portions of the ink chamber and the ink pool for etching are provided in opposite surfaces of the silicon substrate, there may be an error due to mask alignment in the photo etching from the both surfaces of the silicon substrate and so the thickness δ of the partition wall between the ink chamber and the ink pool may be varied. Further, the thickness of the partition wall may be varied by thickness variation of the silicon substrate and deviation thereof from the crystal faces.

A relation between the ink chamber and the ink pool when the thickness of the partition wall between the ink chamber and the ink pool is varied will be described with reference to FIG. 5a, which is a cross section showing the connecting portion between the ink chamber and the nozzle, and FIG. 5b, which is a plan view of the nozzle when looked from the bottom of the ink chamber.

In the case where there is a positional error between the opening portions of the ink chamber and the ink pool, the thickness δ of the partition wall varies. Incidentally, the length of the ink supply path 13 provided between the ink chamber and the ink pool is determined by the thickness δ of the partition wall and the ink supply characteristics to the ink chamber is determined by the thickness δ and the width w of the partition wall. Assuming that an average length of the ink supply path is 100 μm, the variation of the length of the ink supply path becomes 100±100 μm. When the length of the ink supply path is too large, a resistance against the supply of ink to the ink chamber becomes large, so that a high speed ink supply becomes impossible. On the contrary, when the length of the ink supply path is too small, there may be a phenomenon of return of ink in the ink chamber to the side of the ink pool during an ink jetting period, so that the designed ink jetting function can not be obtained.

In the fabrication steps shown in FIG. 4a to FIG. 4g, the opening portion for etching the ink chamber and the opening portion for etching the ink pool are formed in the opposite surfaces. The photo mask patterns therefor are formed on these surfaces and the ink chamber and the ink pool are formed by etching the substrate by using the photo mask patterns. However, since the positions of the ink chamber and the ink pool are set by these photo masks, a deviation of one of the photo masks may occur with respect to the other. Therefore, when the ink chamber and the ink pool are formed by etching the silicon substrate from the opening portions formed in the opposite surfaces thereof, the thickness of the partition wall between the ink chamber and the ink pool may be varied due to the deviation between the masks. Further, such thickness variation of the partition wall may occur due to a slight inclination of the silicon substrate and/or a deviation of the silicon substrate from crystal face.

### SUMMARY OF THE INVENTION

An object of the present invention is to provide an ink jet recording head, which can absorb thickness variation of a partition wall between an ink chamber and an ink pool of the ink jet recording head, which is formed in a silicon substrate.

Another object of the present invention is to provide a fabrication method of an ink jet recording head, which can absorb thickness variation of a partition wall between an ink chamber and an ink pool of the ink jet recording head, which is formed in a silicon substrate.

A further object of the present invention is to provide an ink jet recording head capable of performing a high quality printing.

A variation of thickness of a partition wall between an ink chamber and an ink pool, that is, a variation of length of an ink supply path, is caused by positional deviation between photo masks provided on respective surfaces of a silicon substrate for forming etching patterns, a variation of thickness of the silicon substrate and deviation thereof from crystal face, etc., and it is difficult to eliminate the thickness variation of the partition wall itself. According to the present invention, an opening portion for an ink chamber is provided in a position of a surface of the silicon substrate, which corresponds to an apex of a tapered ink pool, anisotropic etching of the silicon substrate is performed through the opening portion to provide a lateral gap for absorbing a deviation of anisotropic etching from the other surface of the silicon substrate in the apex portion of the ink pool.

That is, simultaneously with the formation of the opening portion for the etching of the ink chamber, an opening portion is formed in a portion corresponding to the apex of the ink pool. Since this opening portion is formed simultaneously with the formation of the pattern of the opening portion for the ink chamber, there is no positional deviation between these opening portions and the formation of these opening portions can be formed precisely. And then, when the ink chamber is etched, the anisotropic etching is performed from the apex of the ink pool to form the laterally extending gap in the vicinity of the apex. The etching from the apex is connected to the anisotropic etching from the opening portion for the ink pool on the other surface of the substrate at a position shifted to a center of the silicon substrate in the thickness direction thereof. Since the connecting portion is moved to the center in the thickness direction of the silicon substrate and the anisotropic etching from the other surface of the silicon substrate does not progress over the gap, the thickness of the partition wall between the ink pool and the ink chamber is determined by the preciseness of the mask pattern on the side of the ink chamber and variation thereof is reduced.

That is, the present invention resides in an ink jet recording head comprising a silicon substrate, at least one ink chamber for pressurizing ink filling the ink chamber, the ink chamber being formed in the silicon substrate and tapered in one direction, at least one ink pool for supplying ink to the ink chamber, the ink pool being formed in the silicon substrate and tapered in an opposite direction to the tapering direction of the ink chamber, the ink pool being arranged adjacent to the ink chamber through a partition wall, the partition wall being formed by performing anisotropic etching of the silicon substrate such that surfaces of said partition wall become crystal faces {111}, the ink pool having hysterisis of anisotropic etching from the same surface of the silicon substrate as that from which anisotropic etching of the ink chamber is performed.

Further, the present invention resides in a fabrication method for fabricating an ink jet recording head including a silicon substrate, at least one ink chamber formed in the silicon substrate for pressurizing ink filling the ink chamber and at least one ink pool formed in the silicon substrate for supplying ink to the ink chamber, which comprises the steps of forming at least one opening portion for etching in a region of one surface of the silicon substrate, in which the ink pool is to be formed, forming opening portions for etching in a region of the other surface of the silicon substrate, in which the ink chamber is to be formed, and in a region in the vicinity of an apex of the ink pool, respectively, and performing anisotropic etching through the opening portions for the ink chamber and the apex of the ink pool and through the opening for the ink pool simultaneously.

In this case, it is possible to perform the anisotropic etching of the one surface of the silicon substrate and the other surface of the silicon substrate separately.

Further, the anisotropic etching step is performed such that the ink chamber and the ink pool are tapered oppositely through a partition wall and surfaces of the partition wall become crystal faces {111}.

### BRIEF DESCRIPTION OF THE DRAWINGS

Specific embodiments of the present invention will now be described, by way of example only, with reference to the accompanying of drawings in which:

FIG. 1a to FIG. 1c illustrate a progress of anisotropic etching of an ink pool of an ink jet recording head according to the present invention;

FIG. 2a to FIG. 2f illustrate fabrication steps of a fabrication method according to a first embodiment of the present invention;

FIG. 3a to FIG. 3f illustrate fabrication steps of a fabrication method according to a second embodiment of the present invention;

FIG. 4a to FIG. 4g illustrate fabrication steps of a conventional fabrication method; and

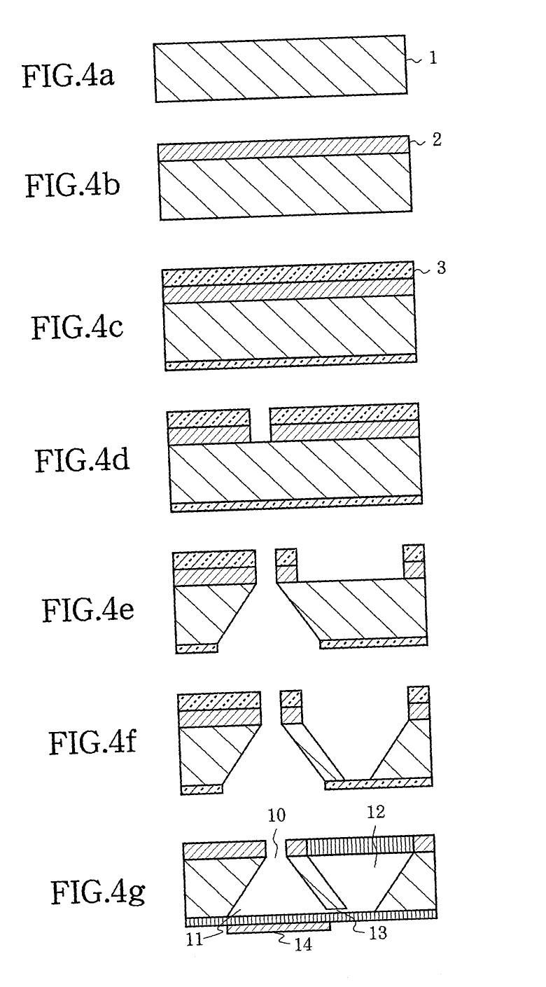

FIG. 5a and FIG. 5b illustrate a deviation of axes of an ink chamber and a nozzle.

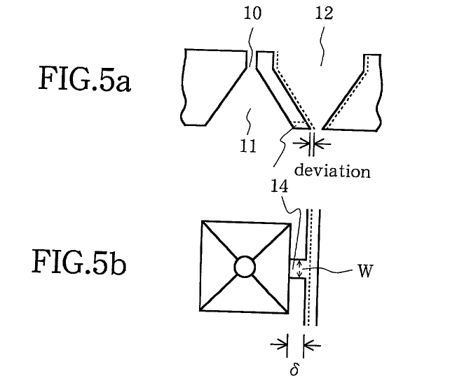

### DETAILED DESCRIPTION OF THE PREFERRED EMBODIMENTS

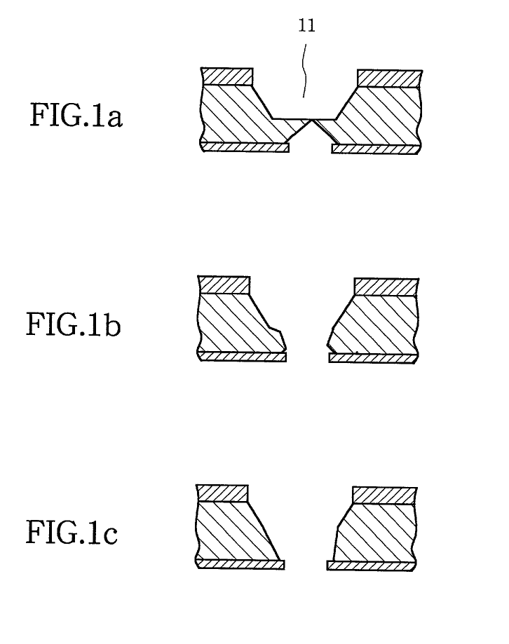

An embodiment of the present invention is featured by that an opening portion is formed in a position in a surface of a silicon substrate, which corresponds to an apex of an ink pool, and anisotropic etching is performed through the opening portion in synchronism with an etching of an ink chamber, as shown in FIG. 1a to FIG. 1c. In this embodiment, anisotropic etching on the side of the opening portion of the ink chamber and anisotropic etching on the side of an opening portion of an ink pool are performed simultaneously. Since the size of the opening portion at the apex of the ink pool is smaller than that of the opening portion of the ink pool, a pyramid shaped cavity defined by four crystal faces {111} is formed in the opening portion at the apex in an initial stage of etching. Subsequent thereto, only side etching progresses for the crystal faces {111} and the vertical etching is not progressed substantially. Anisotropic etching from the opening portion of the ink pool progresses and, finally, the cavity at the apex of the ink pool becomes in contact with the cavity formed by anisotropic etching from the opening portion of the ink pool as shown in FIG. 1a. The contact of the two cavities is made in a position close to the opening portion at the apex of the ink pool in a thickness direction of the silicon wafer 1. Thereafter, the cavities are connected with progress of the etching of the ink pool and protruded portions of the connected portion are selectively etched away to form smooth faces (FIG. 1b and FIG. 1c). This etching is performed such that a cross point of the apex of the ink pool and lines extended from the opening portion (bottom plane) of the ink pool along the crystal faces {111} is positioned inside a gap (or step) formed immediately below the apex of the ink pool.

By forming the ink pool in this manner, the connected portion of the two cavities formed by etching from the opening portion of the ink pool and the opening of the apex of the ink pool (on the opening portion of the ink chamber) is shifted in the thickness direction of the silicon wafer 1 and, therefore, a deviation caused by positional deviation of the photo mask on the side of the opening portion of the ink pool with respect to the photo mask on the side of the opening portion at the apex of the ink pool can be absorbed at the apex of the ink pool as shown in FIG. 1c and, therefore, such deviation does not influence on the ink jetting characteristics of the ink jet recording head. This is because, even when there is some deviation on the side of the opening portion of the ink pool as well as on the side of the opening portion at the apex of the ink pool, anisotropic etching from the side of the opening portion of the ink pool does not progress out of a width of the gap immediately below the apex of the ink pool and, therefore, the deviation between the photo masks on the opposite surfaces of the silicon wafer is absorbed by the gap.

It is possible to make the influence of the matching error of the photo masks on the both surfaces of the silicon wafer smaller by increasing the width of the gap (distance from the opening portion at the apex of the ink pool). However, in order to increase the gap width, it is necessary to make the partition wall between the ink pool and the ink chamber thinner, so that the mechanical strength of the partition wall becomes a problem and it may become impossible to obtain the ink supply path having an appropriate length. In a case where a length (width of the bottom plane) of one side of the opening portion of the ink pool is 400 to 500μm, the width of the opening portion at the apex of the ink pool is 100 μm and the thickness of the partition wall is 70 to 130 μm, preferably, 120 to 130 μm, deviation in the order of 20 to 3 μm can be absorbed.

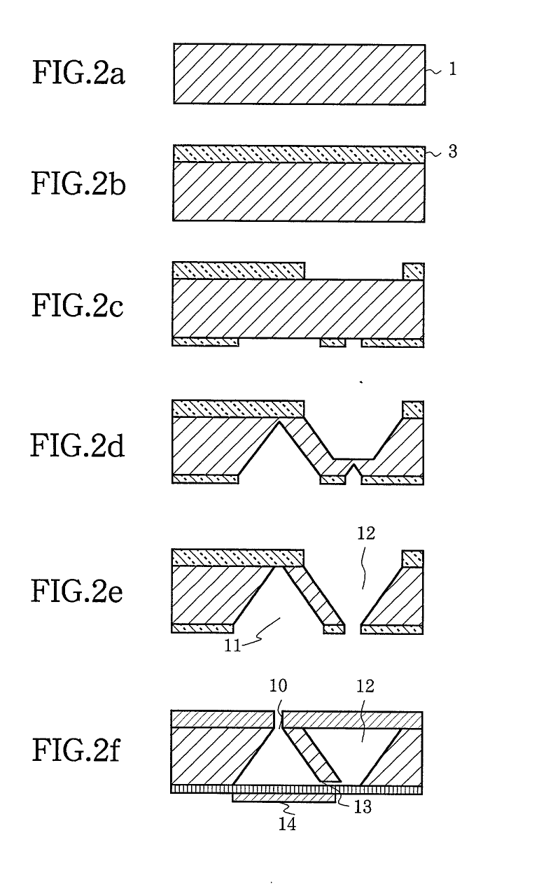

A first embodiment of the fabrication method according to the present invention will be described with reference to FIG. 2a to FIG. 2f.

First, a silicon oxide layer 2 μm thick, which becomes an anti etching mask, is formed on crystal face {100} of a silicon wafer 1 by thermal oxidation, a photo resist is formed thereon by painting, an opening pattern for forming an ink pool is formed on one surface of the silicon wafer and an opening portion at an apex of the ink pool and an opening portion of an ink chamber are formed on the other surface of the wafer as in the conventional method (FIG. 2c). Thereafter, the ink chamber cavity and the ink pool cavity defined by crystal faces {111} are formed by performing anisotropic etching from the ink chamber opening portion and the ink pool opening portion simultaneously (FIG. 2d and FIG. 2e). Finally, the silicon oxide layer is removed by hydrofluoric aid solution, a cover plate formed of synthetic resin or metal and formed with a nozzle is bonded thereto, a cover plate is bonded on the side of the ink pool and a ink supply path and a pressure generating mechanism, etc., are provided, resulting in an ink jet recording head unit. Incidentally, it is possible to form the nozzle after a cover plate for nozzle is bonded thereto.

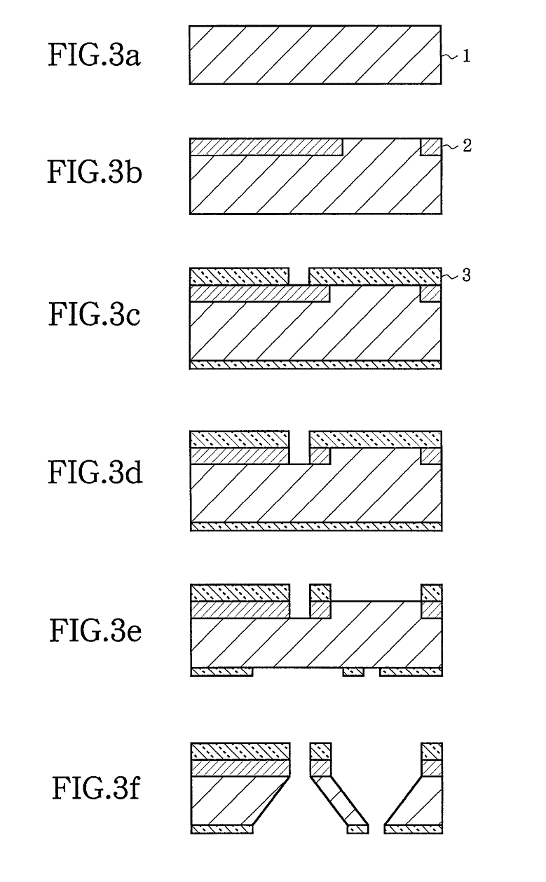

FIG. 3a to FIG. 3f show a second embodiment of the fabrication method according to the present invention in which a nozzle is formed in a silicon substrate.

First, a high density boron diffusion layer for forming the nozzle is formed by doping boron to one of crystal faces {100} of a silicon wafer 1 (FIG. 3a and FIG. 3b). The high density boron diffusion layer is about 8 μm thick and has a portion not doped with boron in which an opening portion of an ink pool is to be formed. And then, a silicon oxide layer 2 μm thick, which becomes an anti etching mask, is formed by thermal oxidation, a photo resist is formed thereon by painting, an opening pattern for forming the nozzle is formed on one surface of the silicon wafer (FIG. 3c). Thereafter, the nozzle is formed by dry etching of the high density boron diffusion layer 2 (FIG. 3d). And then, a photo etching pattern is formed on the other surface of the wafer by putting a photo mask with positional matching to form the opening portion of the ink pool on the nozzle side and the opening portions of the ink chamber and at an apex of the ink pool in the other surface (FIG. 3e). Thereafter, the ink chamber cavity and the ink pool cavity are formed by performing anisotropic etching from the ink chamber opening portion and the ink pool opening portion simultaneously (FIG. 3f). The anisotropic etching is performed in ethylenediamine pyrocatechol water (EPW), which has a selectivity for high density boron diffusion layer. Finally, the silicon oxide layer is removed by hydrofluoric acid solution and an ink jet recording head is obtained by providing an ink supply path and a pressure generating mechanism, etc.

Incidentally, although the anisotropic etching in the embodiments shown in FIG. 2a to FIG. 2f and FIG. 3a to FIG. 3f has been described as being performed from the opening portions of the ink chamber and the ink pool simultaneously, it is possible to provide the same structure as that shown in FIG. 1a to FIG. 1c by forming one of the pyramid shaped cavities by anisotropic etching and then forming the other cavity by anisotropic etching by providing the opening portion thereof.

As described hereinbefore, since it is possible according to the present invention to absorb a positional error between an ink pool and an ink chamber of an ink jet recording head if any to thereby reduce variation of length of an ink supply path, the ink filling function and the ink jetting function of the ink jet recording head are not influenced by such variation, resulting in a high quality printing.

What is claimed is:

1. An ink jet recording head comprising:
a silicon substrate;
at least one ink chamber for pressurizing ink filling said ink chamber, said ink chamber being formed in said silicon substrate and tapered in one direction;
at least one ink pool for supplying ink to said ink chamber, said ink pool being formed in said silicon substrate and tapered in an opposite direction to the tapering direction of said ink chamber, said ink pool being arranged adjacent to said ink chamber through a partition wall;
said partition wall being formed by performing anisotropic etching of said silicon substrate such that surfaces of said partition wall become crystal faces {111};
said ink pool having hysterisis of anisotropic etching from the same surface of said silicon substrate as that from which anisotropic etching of said ink chamber is performed.

2. A fabrication method for fabricating an ink jet recording head including a silicon substrate, at least one ink chamber formed in said silicon substrate for pressurizing ink filling said ink chamber and at least one ink pool formed in said silicon substrate for supplying ink to said ink chamber, comprising the steps of:
forming at least one opening portion for etching in a region of one surface of said silicon substrate, in which said ink pool is to be formed;
forming opening portions for etching in a region of the other surface of said silicon substrate, in which said ink chamber is to be formed, and in a region in the vicinity of an apex of said ink pool, respectively; and
performing anisotropic etching through said opening portions for said ink chamber and said apex of said ink pool and through said opening for said ink pool simultaneously.

3. A fabrication method for fabricating an ink jet recording head including a silicon substrate, at least one ink chamber formed in said silicon substrate for pressurizing ink filling said ink chamber and at least one ink pool formed in said silicon substrate for supplying ink to said ink chamber, comprising the steps of:
forming at least one opening portion for etching in a region of one surface of said silicon substrate, in which said ink pool is to be formed;
forming opening portions for etching in a region of the other surface of said silicon substrate, in which said ink chamber is to be formed, and in a region in the vicinity of an apex of said ink pool, respectively; and
performing anisotropic etching of said one surface of said silicon substrate and said the other surface of said silicon substrate separately.

4. A fabrication method as claimed in claim 2 or 3, wherein the anisotropic etching step is performed such that said chamber and said ink pool are tapered oppositely through a partition wall and surfaces of said partition wall become crystal faces {111}.
